(19) United States
(12) Patent Application Publication
(10) Pub. No.: US 2016/0247158 A1
(43) Pub. Date: Aug. 25, 2016

(54) SYSTEM AND METHOD FOR DETECTING FRAUDULENT ONLINE TRANSACTIONS

(71) Applicant: Kaspersky Lab ZAO, Moscow (RU)

(72) Inventor: Evgeny B. Kolotinsky, Moscow (RU)

(21) Appl. No.: 14/721,872

(22) Filed: May 26, 2015

(30) Foreign Application Priority Data
Feb. 20, 2015 (RU) 2015105806

(51) Int. Cl. G06Q 20/40; G06F 21/62; H04L 29/06

(52) U.S. Cl. CPC G06Q 20/4016; G06Q 20/405; H04L 63/1425; H04L 63/1416; G06F 21/6245

(57) ABSTRACT

Disclosed is a system and method for detecting fraudulent transactions. An example method includes receiving data relating to an electronic transaction, including at least one of user actions data and malware actions data; analyzing, the data to determine whether the electronic transaction is a possible fraudulent transaction based on a predetermined algorithm stored in an electronic memory; determining whether the possible fraudulent transaction is a legitimate electronic transaction, and adjusting the operating parameters of the predetermined algorithm if the hardware processor determines that the possible fraudulent transaction is a legitimate electronic transaction.

### CROSS-REFERENCE TO RELATED APPLICATIONS

This application claims benefit of priority under 35 U.S.C. 119(a)-(d) to a Russian Application No. 2015105806 filed on Feb. 20, 2015, which is incorporated by reference herein.

### FIELD OF TECHNOLOGY

The present disclosure related generally to the field of computer security, more specifically, to a system and method of detecting fraudulent online transactions.

### BACKGROUND

Today, there are a large number of software applications that can be used to perform various online transactions. Many transactions are carried out with the aid of online banking, using standard browsers, and separate banking clients are also used, being especially popular on mobile platforms. When using a browser to perform a transaction, the user generally goes to the bank site and performs an authorization (which is sometimes a two-factor type, for example, using an SMS or token), after which he is able to perform operations with his funds.

Not surprisingly, with the growth of online payments hackers have become increasingly interested in this service area, actively exploring ways to intercept transaction data so as to unlawfully transfer funds. The theft of data is generally done using a malicious program that is installed onto a computer of a user, thus infecting the computer. Most often, such programs infect computers via popular Internet browsers; data may be intercepted as it is entered via input devices (such as keyboard or mouse), or when it is transmitted to the web browser. For example, malicious programs that infect browsers gain access to browser files, history of web page visits and user passwords for visited web pages. Keyloggers intercept the entry of data from keyboard or mouse, take screenshots, and hide their presence in the system by means of a whole range of rootkit technologies. Similar technologies are also used to intercept network packets (traffic sniffers), which intercept network packets being transmitted and extract valuable information from them, such as passwords and other personal data. It should be appreciated that the infection occurs most often by utilizing vulnerabilities in the software, making possible the use of various exploits to get into the computer system.

Existing antivirus technologies, such as the use of signature matching, heuristic analysis, proactive protection or the use of lists of trusted applications (i.e., whitelists), although able to detect many malicious programs on the computers of users, are not always able to identify many of their new modifications or variations of viruses, which are appearing with increasing frequency. Thus, solutions are needed that can ensure that online transactions, such as online payments, are safe for users.

Given the growing number of hacking attacks on online services and transactions, banks are using their own ways of verifying authenticity of online transactions. One such verification is based on analysis of data being entered by the user in order to identify the working of malicious programs e.g., bats). For example, some systems detect fraud based on anomalies associated with an excessively high value of a particular data entry parameter. Other systems may detect fraud based on an excessively large change in certain parameters (such as the number of transactions carried out).

However, conventional systems do not provide a way of detecting and handling false positives (errors of the first kind), yet the quality of the service provided by financial organization (e.g., banks, e-commerce websites) depends directly on the number of such errors. Therefore, there is a need for improved systems and methods of detecting fraudulent online transactions.

### SUMMARY

The disclosed system and method for optimizing detection of fraudulent online transactions. In one aspect, an example method for detecting fraudulent transactions includes: receiving, by a communication interface, data relating to an electronic transaction, including at least one of user actions data and malware actions data; analyzing, by a hardware processor, the data to determine whether the electronic transaction is a possible fraudulent transaction based on a predetermined algorithm stored in an electronic memory; determining, by the hardware processor, whether the possible fraudulent transaction is a legitimate electronic transaction; and adjusting, by the hardware processor, operating parameters of the predetermined algorithm if the hardware processor determines that the possible fraudulent transaction is a legitimate electronic transaction.

In another aspect, the data relating to an electronic transaction is a number of events performed by a computer executing the requesting electronic transaction during a predetermined time period.

In another aspect, the events performed by the computer can include at least one of a number of activations of keys on a keyboard, a number of activations of buttons of a computer mouse, a trajectory of movement of the mouse or a track ball, downloading of webpages, a frequency of selecting links on the webpages, a timing of keystrokes, and a presence and correction of errors during keystrokes.

In another aspect, the predetermined time period is at least one of the operating parameters of the predetermined algorithm.

In another aspect, the method includes adjusting the operating parameters by calculating an average frame value by dividing an average duration of time of the electronic transaction performed by the computer by the number of events performed by the computer; calculating a minimum frame value by dividing a minimum duration of time of the electronic transaction performed by the computer by a number of events performed by the computer; calculating respective reciprocals of the average frame value and the minimum frame value; and updating the predetermined time period as an average value of respective calculated reciprocals.

In another aspect, the method includes adjusting the operating parameters by dividing time of the electronic transaction performed by the computer into a plurality of frames of equal duration; counting the number of events in each of the plurality of frames; calculating an average value and a dispersion of the number of events in each of the plurality of frames; calculating a cost function according to the following formula;

$${C}_{n} ( Δ ) = \frac{2 k - v}{{( n Δ )}^{2}} ,$$

wherein k is the average value, ν is the dispersion, Δ is the duration of each of the plurality of frames, and n is a number of adjustments to the predetermined algorithm; and updating the predetermined time period to minimize the calculated cost function.

In another aspect, the method includes adjusting the operating parameters by setting a time of the electronic transaction performed by the computer as a single frame; counting the number of events in the single frame; if the number of events is greater than 0, dividing the single frame into two equal frames; continuously dividing each of the two equal frames into two additional equal frames, respectively, until one of the additional equal frames has zero number of events; and updating the predetermined time period based on a frame size of the one additional equal frames that has zero number of events.

In another aspect a system is disclosed for detecting fraudulent transactions, the system including a communication interface configured to data relating to an electronic transaction; and a hardware processor configured to analyze the data to determine whether the electronic transaction is a possible fraudulent transaction based on a predetermined algorithm stored in an electronic memory, determine whether the possible fraudulent transaction is a legitimate electronic transaction, and, adjust operating parameters of the predetermined algorithm if the hardware processor determines that the possible fraudulent transaction is a legitimate electronic transaction.

In another aspect, a non-transitory computer readable medium is disclosed for storing computer executable instructions for detecting fraudulent transactions, including instructions for: receiving, by a communication interface, data relating to an electronic transaction; analyzing, by a hardware processor, the data to determine whether the electronic transaction is a possible fraudulent transaction based on a predetermined algorithm stored in an electronic memory; determining, by the hardware processor, whether the possible fraudulent transaction is a legitimate electronic transaction; and adjusting, by the hardware processor, operating parameters of the predetermined algorithm if the hardware processor determines that the possible fraudulent transaction is a legitimate electronic transaction.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and particularly pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 illustrates a histogram of example user actions for online transactions.

FIG. 2 illustrates an exemplary system for identifying false positives in the detection of fraudulent online transactions.

FIG. 3 illustrates an exempla method of identifying false positives in the detection of fraudulent online transactions.

FIG. 4 illustrates an example of a general-purpose computer system (which may be a personal computer or a server) on which the disclosed systems and method can be implemented according to an example aspect.

### DETAILED DESCRIPTION

The disclosed system and method eliminates the drawbacks of conventional solutions for preventing online fraud and identification of false positives in the detection of fraudulent online transactions. Example aspects are described herein in the context of a system, method and computer program product for detecting fraudulent transactions on a computer. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

In general, a computer user attempting to make an online purchase or perform a series of actions with his funds on a banking website will perform a series of actions, including, but not limited to pressing the keys of a mouse or keyboard, loading certain pages, performing transactions, performing data entry/output, performing other actions relating to online transactions and the like. A session is a set of such user actions which are limited by a certain framework—generally, a period of time. The period of time can be fixed (such as 10 minutes) or depend on certain parameters (e.g., the session time, dictated by the user entering and leaving the site).

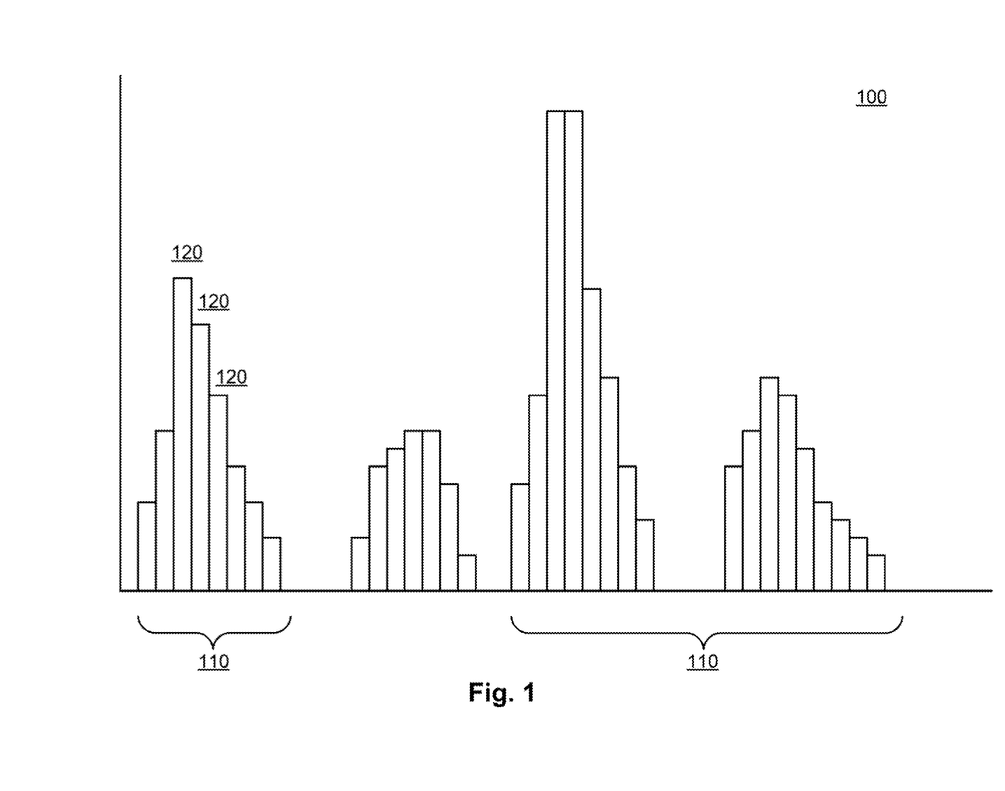

FIG. 1 illustrates a histogram of user actions for online transactions. As shown, the histogram 100 illustrates the number of user actions depending on time. For exemplary purposes, FIG. 1 assumes that the histogram 100 represents a single user session. In particular, each column 120 shows an exemplary number of actions in a given interval of time (e.g., one second). The set of columns 120 forms a frame 110, the size of which can vary. Thus, one skilled in the art would understand that a session can include several frames. For purposes of this disclosure, it is assumed that a session includes one or more frames 110. From the standpoint of analysis, frames 110 are used for the logic of identifying fraudulent transactions. In general, the system and method disclosed herein performs an analysis of events that occurs within a selected frame 110 for identification of deviations (e.g., anomalies), which, in turn, can be interpreted as fraudulent transactions performed by a malicious program (i.e., malware).

The disclosed system and method solves the problem of selecting the size of the frame 110 so as to eliminate possible false positives connected with the user's actions.

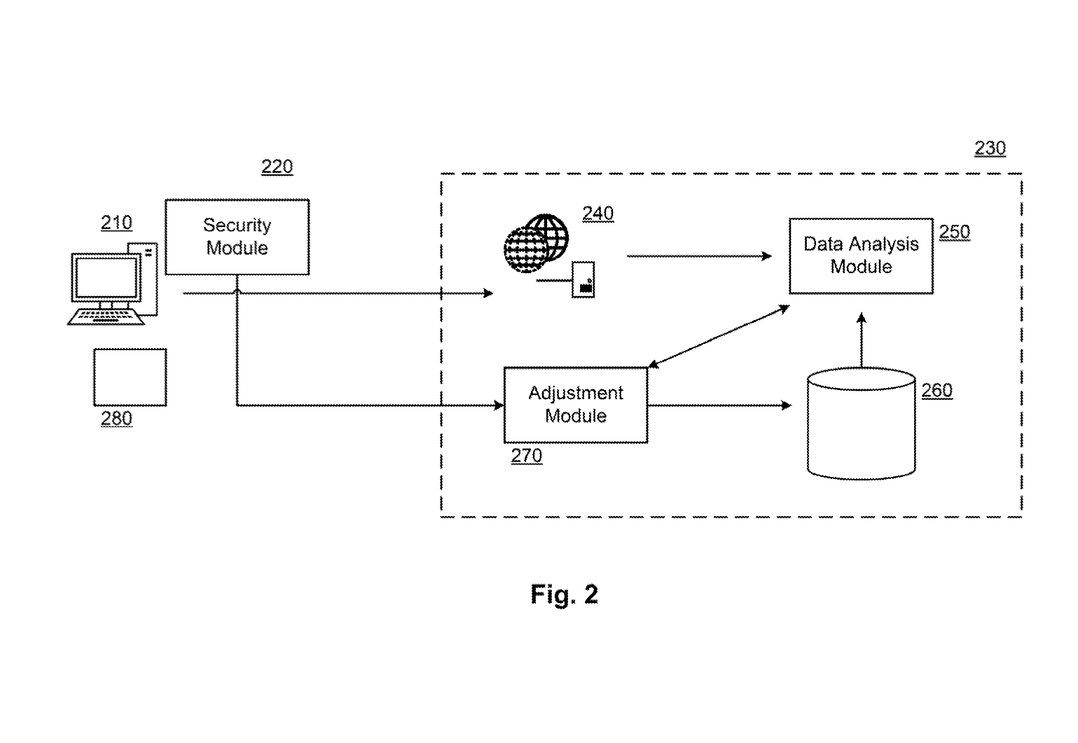

FIG. 2 illustrates an exemplary system 230 for identifying false positives during detection of fraudulent online transactions. In an exemplary aspect, a malicious program 280 may be installed on a user's computer 210, which can perform one or more fraudulent transactions from the user's computer 210 without the user's knowledge. Transactional data is then transmitted to a web service 240 of a bank or payment service, where it will normally be processed to execute the transaction at the server end (backend, not shown in FIG. 2). To evaluate the transaction from the standpoint of a fraudulent action, the transactional data, which may include user actions data and/or malware actions data, is provided to a data analysis module 250 that uses rules from a rules database 260 to detect a fraudulent transaction.

It is contemplated that the methods of detection are similar to those discussed above and are based on data such as the number of actions performed in a unit of time. In general, fraudulent transactions are characterized by a number of anomalies as compared to the usual transactions performed by a person. For example, a person enters data on the transaction for a rather long time by using the mouse to switch between elements of the data entry window and the like. In contrast, Trojan horse programs using fraudulent methods of data entry are generally different than a user transaction, for example, during their execution, there is no actual data entry from mouse or keyboard, the data entry is rather fast, and the like. The data analysis module 250 can determine these differences to detect a possible fraudulent transaction.

On the other hand, it is certainly possible that there can be false positives when, for example, a poorly adjusted data analysis module or incorrect rules for detecting a fraudulent transaction block a transaction from user if the user's actions resemble a possible fraudulent transaction. In order to eliminate or reduce false positives, system 230 includes an adjustment module 270 that is configured to change the operating parameters of the data analysis module 250 or the database 260.

In one exemplary aspect, a security module 220, such as antivirus software, is also installed on the computer 210, which transmits additional information about the user transaction to the adjustment module 270. The security module 220 is generally configured to detect a malicious program 280 as would be understood to one skilled in the art, but this detection is not always possible when the antivirus databases is not updated in the security module 220 or the modules for their detection are switched off.

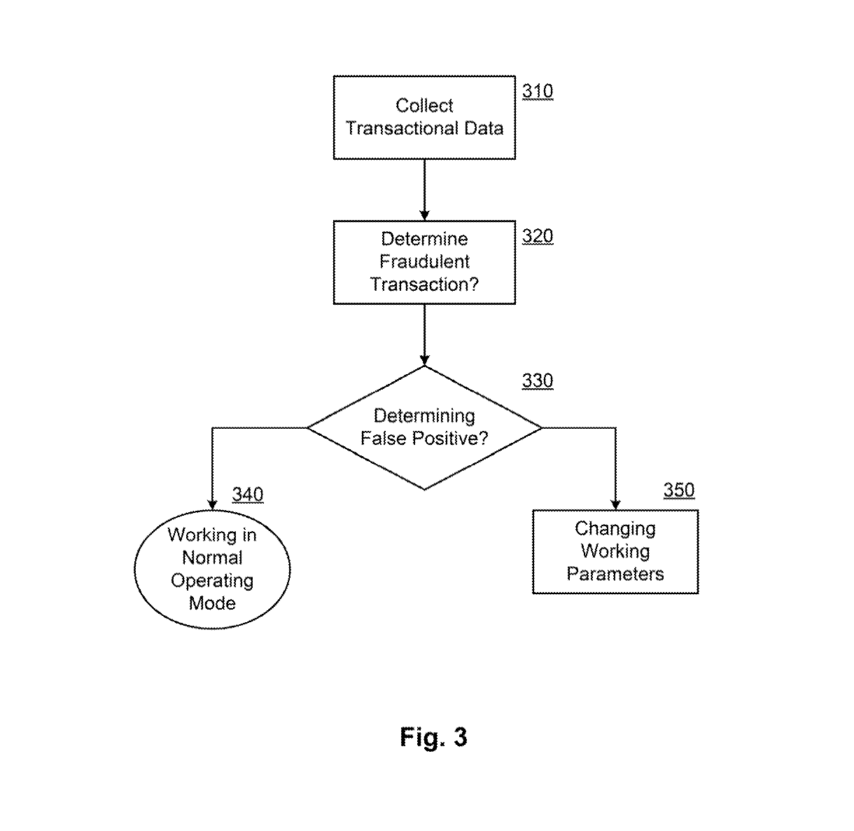

FIG. 3 illustrates an exemplary method of identifying false positives during detection of fraudulent transactions. As shown, in step 310, transactional data is collected during the transaction. Based on the collected data, one or more possible fraudulent transactions are determined in step 320. Next, in step 330, the method checks the possibility of a false positive based on the transactional data. If no false positive is identified, the system continues operating in normal mode in step 340, which can include repeating steps 310-330 as a loop. In the event a false positive is identified, the system is configured to change the operating parameters in step 350. The details of the steps shown in FIG. 3 will be discussed next.

According to an exemplary aspect, step 310 may include obtaining information from the user's computer 210 and/or from the web service 240 of the bank in conjunction with the data analysis module 250. The data can be collected within one or more frames 110 and can include, but is not limited to (i) the number of activations of keys on the keyboard or buttons of the mouse; (ii) the trajectory of movement of the mouse or track ball; (iii) the downloading of web pages; (iv) the frequency (speed) of clicking on links on the web pages; and (v) peculiarities of the data entry by the user (e.g., a pause between key strokes, presence and correction of errors during entry, features of using the mouse and filling out data entry fields on the web page and the like.

As described above, this data (which can be considered user actions or events) is input into the algorithms for determining fraudulent transactions. As described above, there are many known algorithms for detection of fraudulent transactions that operate in a similar manner, which is based on identification of anomalies in the set of data entered, when a transaction from a malicious program will differ from a transaction executed by an actual computer user. Examples of such algorithms for detection of fraudulent transactions are disclosed in U.S. Pat. No. 8,650,080 and US Pub. 2012/0204257, both of which are incorporated by reference herein.

However, as described above, these algorithms for detection of fraudulent transactions are not immune to false positives. In other words, the algorithm may mistakenly identify a legitimate electronic transaction as fraudulent. This may happen, for example, when specific behavior of a user in the data entry during the transaction might be partially similar to the working model of a malicious program, which may cause the transaction to be identified as fraudulent and blocked by the data analysis module 250. To correct these mistakes, the disclosed method identifies in step 330 false positives (i.e., legitimate electronic transaction that were identified as fraudulent).

In various aspects, false positives may be identified in different ways: (i) receiving a notification from the user of the computer 210 with information about failed electronic transaction, which helps to identify the transaction as legitimate; (ii) receiving a notification from the security module 220 that the fraudulent transaction is in fact legitimate and safe; and other methods known to those of ordinary skill in the art.

When a false positive is detected, the system 230 is configured to change the working parameters of the above-indicated algorithm(s) for detection of fraudulent transactions performed in step 350. In one aspect, the working parameters may be changed by changing the size of the frames 110 depending on the number of events.

In one exemplary aspect, the training of the algorithms may include: collecting data on the sessions (for example, duration); calculating an average value for the frame 110 (e.g., average duration of a session divided by the average number of events during the session); calculating a minimum value for the frame 110 (e.g., dividing minimum duration of the session by the minimum number of events during the session); calculating the reciprocals of the average and the minimum values for the frame 110; and the updating the frame size 110 as the average value of two calculated reciprocals.

In another exemplary aspect, the training of the algorithms may include: dividing a session into several frames 110 of equal duration; counting the number of events in each frame 110; calculating the average value and the dispersion of the number of events in each column 120; and calculating the cost function according to the following equation:

$${C}_{n} ( Δ ) = \frac{2 k - v}{{( n Δ )}^{2}} ,$$

where k is the average value, ν is the dispersion, Δ is the frame size, and n is the number of training sessions. Once the cost function is calculated, the frame size 110 is then changed to minimize the cost function.

In another exemplary aspect, the training of the algorithms may include: taking the entire session as one frame 110; counting the number of events in the frame 110; if the number of events is more than 0, dividing the frame into two equal frames; repeating the preceding step until the number of events in one of the frames becomes equal to 0; and choosing the frame size on the basis of the preceding frame division iteration.

According to an exemplary aspect, after the frame size 110 is selected/updated, the system 230 for identifying false positives in detected fraudulent transactions continues operation until a new false positive is detected. According to another aspect, the system can detect false positives based on the accumulation of a certain number of previous false positives. In yet another aspect, the disclosed system 230 can perform the steps illustrated in FIG. 3 only after the ratio of false positives to the total number of fraudulent transactions detected exceeds a certain threshold (e.g., 0.01).

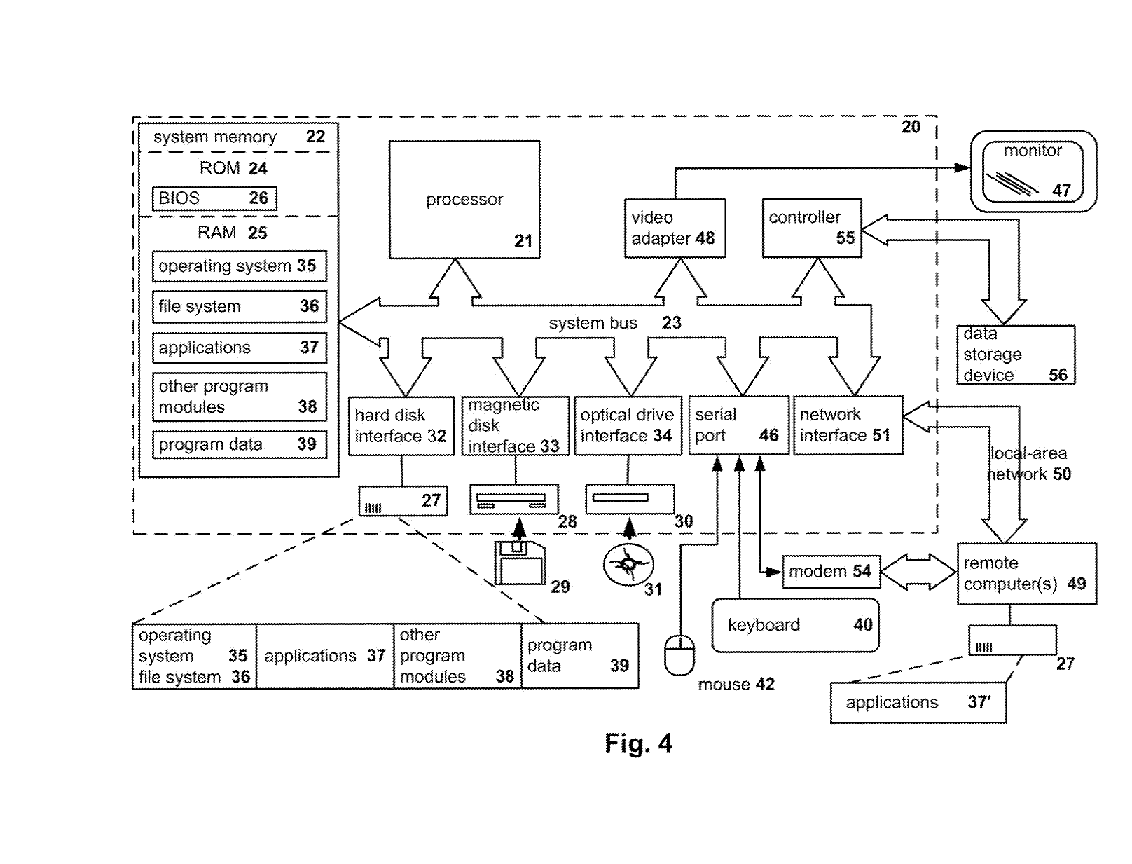

FIG. 4 illustrates an example of a general-purpose computer system (which may be a personal computer or a server) on which the disclosed systems and method can be implemented according to an example aspect. The computer system 20 includes a central processing unit 21, a system memory 22 and a system bus 23 connecting the various system components, including the memory associated with the central processing unit 21. The system bus 23 is realized like any bus structure known from the prior art, including in turn a bus memory or bus memory controller, a peripheral bus and a local bus, which is able to interact with any other bus architecture. The system memory includes read only memory (ROM) 24 and random-access memory (RAM) 25. The basic input/output system (BIOS) 26 includes the basic procedures ensuring the transfer of information between elements of the personal computer 20, such as those at the time of loading the operating system with the use of the ROM 24.

The personal computer 20, in turn, includes a hard disk 27 for reading and writing of data, a magnetic disk drive 28 for reading and writing on removable magnetic disks 29 and an optical drive 30 for reading and writing on removable optical disks 31, such as CD-ROM, DVD-ROM and other optical information media. The hard disk 27, the magnetic disk drive 28, and the optical drive 30 are connected to the system bus 23 across the hard disk interface 32, the magnetic disk interface 33 and the optical drive interface 34, respectively. The drives and the corresponding computer information media are power-independent modules for storage of computer instructions, data structures, program modules and other data of the personal computer 20.

The present disclosure provides the implementation of a system that uses a hard disk 27, a removable magnetic disk 29 and a removable optical disk 31, but it should be understood that it is possible to employ other types of computer information media 56 which are able to store data in a form readable by a computer (solid state drives, flash memory cards, digital disks, random-access memory (RAM) and so on), which are connected to the system bus 23 via the controller 55.

The computer 20 has a file system 36, where the recorded operating system 35 is kept, and also additional program applications 37, other program modules 38 and program data 39. The user is able to enter commands and information into the personal computer 20 by using input devices (keyboard 40, mouse 42). Other input devices (not shown) can be used: microphone, joystick, game controller, scanner, and so on. Such input devices usually plug into the computer system 20 through a serial port 46, which in turn is connected to the system bus, but they can be connected in other ways, for example, with the aid of a parallel port, a game port or a universal serial bus (USB). A monitor 47 or other type of display device is also connected to the system bus 23 across an interface, such as a video adapter 48. In addition to the monitor 47, the personal computer can be equipped with other peripheral output devices (not shown), such as loudspeakers, a printer, and so on.

The personal computer 20 is able to work in a network environment, using a network connection to one or more remote computers 49. The remote computer (or computers) 49 are also personal computers or servers having the majority or all of the aforementioned elements in describing the nature of a personal computer 20, as shown in FIG. 4. Other devices can also be present in the computer network, such as routers, network stations, peer devices or other network nodes.

Network connections can form a local-area computer network (LAN) 50, such as a wired and/or wireless network, and a wide-area computer network (WAN). Such networks are used in corporate computer networks and internal company networks, and they generally have access to the Internet. In LAN or WAN networks, the personal computer 20 is connected to the local-area network 50 across a network adapter or network interface 51. When networks are used, the personal computer 20 can employ a modem 54 or other modules for providing communications with a wide-area computer network such as the Internet. The modem 54, which is an internal or external device, is connected to the system bus 23 by a serial port 46. It should be noted that the network connections are only examples and need not depict the exact configuration of the network, i.e., in reality there are other ways of establishing a connection of one computer to another by technical communication modules, such as Bluetooth.

In various aspects, the systems and methods described herein may be implemented in hardware, software, firmware, or any combination thereof. If implemented in software, the methods may be stored as one or more instructions or code on a non-transitory computer-readable medium. Computer-readable medium includes data storage. By way of example, and not limitation, such computer-readable medium can comprise RAM, ROM, EEPROM, CD-ROM, Flash memory or other types of electric, magnetic, or optical storage medium, or any other medium that can be used to carry or store desired program code in the form of instructions or data structures and that can be accessed by a processor of a general purpose computer.

In various aspects, the systems and methods described in the present disclosure in terms of modules. The term “module” as used herein refers to a real-world device, component, or arrangement of components implemented using hardware, such as by an application specific integrated circuit (ASIC) or field-programmable gate array (FPGA), for example, or as a combination of hardware and software, such as by a microprocessor system and a set of instructions to implement the module's functionality, which (while being executed) transform the microprocessor system into a special-purpose device. A module can also be implemented as a combination of the two, with certain functions facilitated by hardware alone, and other functions facilitated by a combination of hardware and software. In certain implementations, at least a portion, and in some cases, all, of a module can be executed on the processor of a general purpose computer (such as the one described in greater detail in FIG. 3 above). Accordingly, each module can be realized in a variety of suitable configurations, and should not be limited to any example implementation exemplified herein.

In the interest of clarity, not all of the routine features of the aspects are disclosed herein. It will be appreciated that in the development of any actual implementation of the present disclosure, numerous implementation-specific decisions must be made in order to achieve the developer's specific goals, and that these specific goals will vary for different implementations and different developers. It will be appreciated that such a development effort might be complex and time-consuming, but would nevertheless be a routine undertaking of engineering for those of ordinary skill in the art having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of the skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for detecting fraudulent transactions, the method comprising:
receiving, by a communication interface, data relating to an electronic transaction, including at least one of user actions data and malware actions data;
analyzing, by a hardware processor, the data to determine whether the electronic transaction is a possible fraudulent transaction based on a predetermined algorithm stored in an electronic memory;
determining, by the hardware processor, whether the possible fraudulent transaction is a legitimate electronic transaction; and
adjusting, by the hardware processor, operating parameters of the predetermined algorithm when the hardware processor determines that the possible fraudulent transaction is a legitimate electronic transaction.

2. The method of claim 1, wherein the data relating to an electronic transaction is a number of events performed by a computer executing the requesting electronic transaction during a predetermined time period.

3. The method of claim 2, wherein the events performed by the computer include at least one of a number of activations of keys on a keyboard, a number of activations of buttons of a computer mouse, a trajectory of movement of the mouse or a track ball, downloading of webpages, a frequency of selecting links on the webpages, a timing of keystrokes, and a presence and correction of errors during keystrokes.

4. The method of claim 2, wherein the predetermined time period is at least one of the operating parameters of the predetermined algorithm.

5. The method of claim 4, wherein adjusting the operating parameters comprises
calculating an average frame value by dividing an average duration of time of the electronic transaction performed by the computer by the number of events performed by the computer;
calculating a minimum frame value by dividing a minimum duration of time of the electronic transaction performed by the computer by a number of events performed by the computer;
calculating respective reciprocals of the average frame value and the minimum frame value; and
updating the predetermined time period as an average value of respective calculated reciprocals.

6. The method of claim 4, wherein adjusting the operating parameters comprises:
dividing time of the electronic transaction performed by the computer into a plurality of frames of equal duration;
counting the number of events in each of the plurality of frames;
calculating an average value and a dispersion of the number of events in each of the plurality of frames;
calculating a cost function according to the following formula:
$${C}_{n} ( Δ ) = \frac{2 k - v}{{( n Δ )}^{2}} ,$$
wherein k is the average value, ν is the dispersion, Δ is the duration of each of the plurality of frames, and n is a number of adjustments to the predetermined algorithm; and
updating the predetermined time period to minimize the calculated cost function.

7. The method of claim 4, wherein adjusting the operating parameters comprises:
setting a time of the electronic transaction performed by the computer as a single frame;
counting the number of events in the single frame;
if the number of events is greater than 0, dividing the single frame into two equal frames;
continuously dividing each of the two equal frames into two additional equal frames, respectively, until one of the additional equal frames has zero number of events; and
updating the predetermined time period based on a frame size of the one additional equal frames that has zero number of events.

8. A system for detecting fraudulent transactions, the system comprising:
a communication interface configured to data relating to an electronic transaction, including at least one of user actions data and malware actions data; and
a hardware processor configured to:
analyze the data to determine whether the electronic transaction is a possible fraudulent transaction based on a predetermined algorithm stored in an electronic memory,
determine whether the possible fraudulent transaction is a legitimate electronic transaction, and
adjust operating parameters of the predetermined algorithm if the hardware processor determines that the possible fraudulent transaction is a legitimate electronic transaction.

9. The system of claim 8, wherein the data relating to an electronic transaction is a number of events performed by a computer executing the requesting electronic transaction during a predetermined time period.

10. The system of claim 9, wherein the events performed by the computer can include at least one of a number of activations of keys on a keyboard, a number of activations of buttons of a computer mouse, a trajectory of movement of the mouse or a track ball, downloading of webpages, a frequency of selecting links on the webpages, a timing of keystrokes, and a presence and correction of errors during keystrokes.

11. The system of claim 9, wherein the predetermined time period is at least one of the operating parameters of the predetermined algorithm.

12. The system of claim 11, wherein the hardware processor is configured to adjust the operating parameters by:
calculating an average frame value by dividing an average duration of time of the electronic transaction performed by the computer by the number of events performed by the computer;
calculating a minimum frame value by dividing a minimum duration of time of the electronic transaction performed by the computer by a number of events performed by the computer;
calculating respective reciprocals of the average frame value and the minimum frame value; and
updating the predetermined time period as an average value of respective calculated reciprocals.

13. The system of claim 11, wherein the hardware processor is configured to adjust the operating parameters by:
dividing time of the electronic transaction performed by the computer into a plurality of frames of equal duration;
counting the number of events in each of the plurality of frames;
calculating an average value and a dispersion of the number of events in each of the plurality of frames;
calculating a cost function according to the following formula:
$${C}_{n} ( Δ ) = \frac{2 k - v}{{( n Δ )}^{2}} ,$$
wherein k is the average value, ν is the dispersion, Δ is the duration of each of the plurality of frames, and n is a number of adjustments to the predetermined algorithm; and
updating the predetermined time period to minimize the calculated cost function.

14. The system of claim 11, wherein the hardware processor is configured to adjust the operating parameters by:
setting a time of the electronic transaction performed by the computer as a single frame;
counting the number of events in the single frame;
if the number of events is greater than 0, dividing the single frame into two equal frames;
continuously dividing each of the two equal frames into two additional equal frames, respectively, until one of the additional equal frames has zero number of events; and
updating the predetermined time period based on a frame size of the one additional equal frames that has zero number of events.

15. A non-transitory computer readable medium storing computer executable instructions for detecting fraudulent transactions, including instructions for:
receiving, by a communication interface, data relating to an electronic transaction, including at least one of user actions data and malware actions data;
analyzing, by a hardware processor, the data to determine whether the electronic transaction is a possible fraudulent transaction based on a predetermined algorithm stored in an electronic memory;
determining, by the hardware processor, whether the possible fraudulent transaction is a legitimate electronic transaction; and
adjusting, by the hardware processor, operating parameters of the predetermined algorithm if the hardware processor determines that the possible fraudulent transaction is a legitimate electronic transaction.

16. The non-transitory computer readable medium of claim 17, wherein the data relating to an electronic transaction is a number of events performed by a computer executing the requesting electronic transaction during a predetermined time period.

17. The non-transitory computer readable medium of claim 16, wherein the predetermined time period is at least one of the operating parameters of the predetermined algorithm.

18. The non-transitory computer readable medium of claim 17, wherein the computer executable instructions for detecting fraudulent transactions further include instructions for:
calculating an average frame value by dividing an average duration of time of the electronic transaction performed by the computer by the number of events performed by the computer;
calculating a minimum frame value by dividing a minimum duration of time of the electronic transaction performed by the computer by a number of events performed by the computer;
calculating respective reciprocals of the average frame value and the minimum frame value; and
updating the predetermined time period as an average value of respective calculated reciprocals.

19. The non-transitory computer readable medium of claim 17, wherein the computer executable instructions for detecting fraudulent transactions further include instructions for dividing time of the electronic transaction performed by the computer into a plurality of frames of equal duration;
counting the number of events in each of the plurality of frames;
calculating an average value and a dispersion of the number of events in each of the plurality of frames;
calculating a cost function according to the following formula:
$${C}_{n} ( Δ ) = \frac{2 k - v}{{( n Δ )}^{2}} ,$$
wherein k is the average value, ν is the dispersion, Δ is the duration of each of the plurality of frames, and n is a number of adjustments to the predetermined algorithm; and
updating the predetermined time period to minimize the calculated cost function.

20. The non-transitory computer readable medium of claim 17, wherein the computer executable instructions for detecting fraudulent transactions further include instructions for:
setting a time of the electronic transaction performed by the computer as a single frame;
counting the number of events in the single frame;
if the number of events is greater than 0, dividing the single frame into two equal frames;
continuously dividing each of the two equal frames into two additional equal frames, respectively, until one of the additional equal frames has zero number of events; and
updating the predetermined time period based on a frame size of the one additional equal frames that has zero number of events.
